(19) United States
(12) Patent Application Publication
(10) Pub. No.: US 2024/0139783 A1
(43) Pub. Date: May 2, 2024

(54) SENSOR SETTING WITH ELECTROWETTING

(71) Applicant: Ford Global Technologies, LLC, Dearborn, MI (US)

(72) Inventors: Raghuraman Surineedi, Dearborn, MI (US); Segundo Baldovino, Novi, MI (US); Venkatesh Krishnan, Canton, MI (US); Giridharan Nammalwar, Chennai (IN)

(73) Assignee: Ford Global Technologies, LLC, Dearborn, MI (US)

(21) Appl. No.: 18/051,967

(22) Filed: Nov. 2, 2022

(51) Int. Cl. B08B 6/00; B60S 1/56; G01S 7/497

(52) U.S. Cl. CPC B08B 6/00; B60S 1/56; G01S 7/497; G01S 2007/4977

(57) ABSTRACT

A sensor system includes a sensor window including a substrate and a plurality of electrodes applied to the substrate, a sensing device movable relative to the sensor window and having a field of view through the sensor window in at least one position, and a computer communicatively coupled to the sensing device and the electrodes. The computer is programmed to activate the electrodes in a sequence that electrostatically moves a droplet on the sensor window, and the sequence is coordinated with movement of the sensing device relative to the sensor window.

### BACKGROUND

Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back.

### BRIEF DESCRIPTION OF THE DRAWINGS

FIG. 1 is a perspective view of an example vehicle with an example sensor system.

FIG. 2 is a perspective view of a sensor of the sensor system.

FIG. 3 is an exploded perspective view of the sensor.

FIG. 4 is a cross-sectional view of a portion of a sensor window of the sensor.

FIG. 5 is a block diagram of a control system of the sensor system.

FIG. 6 is a diagrammatic perspective view of electrodes on the sensor window.

FIG. 7 is a diagrammatic top view of the electrodes on the sensor window.

FIG. 8 is a process flow diagram of an example process for operating the electrodes.

### DETAILED DESCRIPTION

A sensor system includes a sensor window including a substrate and a plurality of electrodes applied to the substrate, a sensing device movable relative to the sensor window and having a field of view through the sensor window in at least one position, and a computer communicatively coupled to the sensing device and the electrodes. The computer is programmed to activate the electrodes in a sequence that electrostatically moves a droplet on the sensor window, and the sequence is coordinated with movement of the sensing device relative to the sensor window.

The sensor window may be cylindrical and define an axis, and the sensing device may be rotatable around the axis. The sensing device may be configured to rotate around the axis at a preset angular speed, and the sequence of activating the electrodes may include activating the electrodes around the axis at the preset angular speed. The sequence of activating the electrodes may include activating the electrodes located at an angle from the field of view of the sensing device in a direction of rotation of the sensing device relative to the axis, and the angle may be at most 45°.

The sequence of activating the electrodes may include activating the electrodes in a downward direction.

The electrodes may be arranged in a grid on the substrate.

The electrodes may be transparent.

The electrodes may be indium tin oxide.

The sensor window may include a hydrophobic coating over the electrodes.

The sensor window may include a dielectric layer over the electrodes. The sensor window may include a hydrophobic coating over the dielectric layer.

The computer may be further programmed to activate the electrodes in the sequence in response to receiving data from the sensing device indicating a presence of the droplet.

The computer may be further programmed to activate the electrodes in response to receiving data from the sensing device indicating frozen water on the sensor window.

The sensing device may be a LIDAR sensing device.

A computer includes a processor and a memory storing instructions executable by the processor to activate a plurality of electrodes in a sequence that electrostatically moves a droplet on a sensor window including the electrodes and a substrate to which the electrodes are applied, and the sequence is coordinated with movement of a sensing device relative to the sensor window.

The sequence of activating the electrodes may include activating the electrodes in a same direction as movement of a field of view of the sensing device.

The instructions may further include instructions to activate the electrodes in the sequence in response to receiving data from the sensing device indicating a presence of the droplet.

The instructions may further include instructions to activate the electrodes in response to receiving data from the sensing device indicating frozen water on the sensor window. Activating the electrodes in response to frozen water may include activating a subset of the electrodes for a duration longer than a duration of activation when activating the electrodes in the sequence.

A method includes activating a plurality of electrodes in a sequence that electrostatically moves a droplet on a sensor window including the electrodes and a substrate to which the electrodes are applied, and the sequence is coordinated with movement of a sensing device relative to the sensor window.

With reference to the Figures, wherein like numerals indicate like parts throughout the several views, a sensor system 102 of a vehicle 100 includes a sensor window 104 including a substrate 106 and a plurality of electrodes 108 applied to the substrate 106, a sensing device 110 movable relative to the sensor window 104 and having a field of view through the sensor window 104 in at least one position, and a computer 112 communicatively coupled to the sensing device 110 and the electrodes 108. The computer 112 is programmed to activate the electrodes 108 in a sequence that electrostatically moves a droplet on the sensor window 104, and the sequence is coordinated with movement of the sensing device 110 relative to the sensor window 104.

The sensor system 102 provides for quick removal of water droplets, e.g., from rain or mist, providing a clearer view for the sensing device 110 through the sensor window 104. Activating one of the electrodes 108 next to a droplet generates an electrostatic force on the droplet pulling the droplet toward that electrode 108, a process called electrowetting. That electrode 108 can then deactivate while an adjacent electrode 108 activates, continuing to pull the droplet. Coordinating the sequence of activations of the electrodes 108 with the movement of the sensing device 110 can effectively keep the sensor window 104 clear at the moving location at which the sensing device 110 is aimed. For example, the sensing device 110 can rotate around an axis A, and the electrodes 108 can activate in turn around the axis A at a same angular speed as the sensing device 110. The currently active electrode 108 can be slightly ahead of the current location at which the sensing device 110 is aimed, meaning that the current location is recently cleared. With a small amount of time for droplets to accumulate, the current location is likely clear.

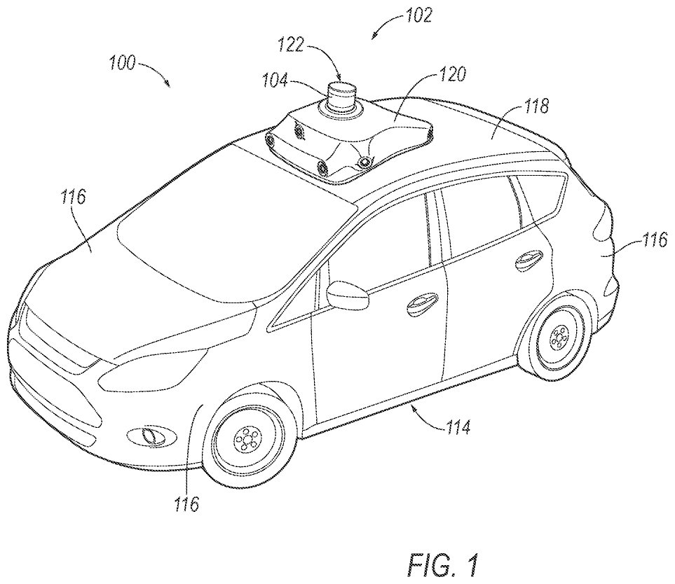

With reference to FIG. 1, the vehicle 100 may be any passenger or commercial automobile such as a car, a truck, a sport utility vehicle, a crossover, a van, a minivan, a taxi, a bus, etc.

The vehicle 100 may be an autonomous vehicle. A vehicle computer can be programmed to operate the vehicle 100 independently of the intervention of a human operator, completely or to a lesser degree. The vehicle computer may be programmed to operate the propulsion, brake system, steering system, and/or other vehicle systems based in part on data received from the sensing device 110. For the purposes of this disclosure, autonomous operation means the vehicle computer controls the propulsion, brake system, and steering system without input from a human operator; semi-autonomous operation means the vehicle computer controls one or two of the propulsion, brake system, and steering system and a human operator controls the remainder; and nonautonomous operation means a human operator controls the propulsion, brake system, and steering system.

The vehicle 100 includes a body 114. The vehicle 100 may be of a unibody construction, in which a frame and a body 114 of the vehicle 100 are a single component. The vehicle 100 may, alternatively, be of a body-on-frame construction, in which the frame supports a body 114 that is a separate component from the frame. The frame and body 114 may be formed of any suitable material, for example, steel, aluminum, etc.

The body 114 includes body panels 116 partially defining an exterior of the vehicle 100. The body panels 116 may present a class-A surface, e.g., a finished surface exposed to view by a customer and free of unaesthetic blemishes and defects. The body panels 116 include, e.g., a roof 118, etc.

A housing 120 of the sensor system 102 is attachable to the vehicle 100, e.g., to one of the body panels 116 of the vehicle 100, e.g., the roof 118. For example, the housing 120 may be shaped to be attachable to the roof 118, e.g., may have a shape matching a contour of the roof 118. The housing 120 may be attached to the roof 118, which can provide the sensing device 110 with an unobstructed field of view of an area around the vehicle 100. The housing 120 may be formed of, e.g., plastic or metal.

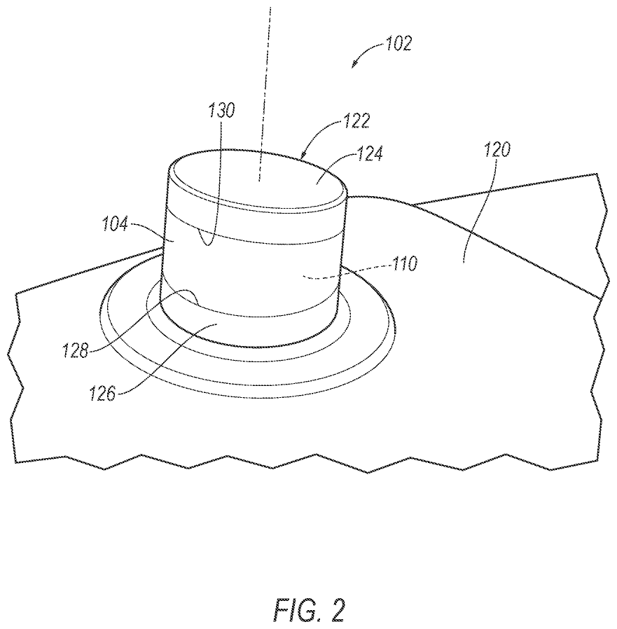

With reference to FIG. 2, the sensor system 102 includes a sensor housing 122. The sensor housing 122 is supported by the housing 120. The sensor housing 122 can be disposed on top of the housing 120 at a highest point of the housing 120. The sensor housing 122 has a cylindrical shape and defines the axis A.

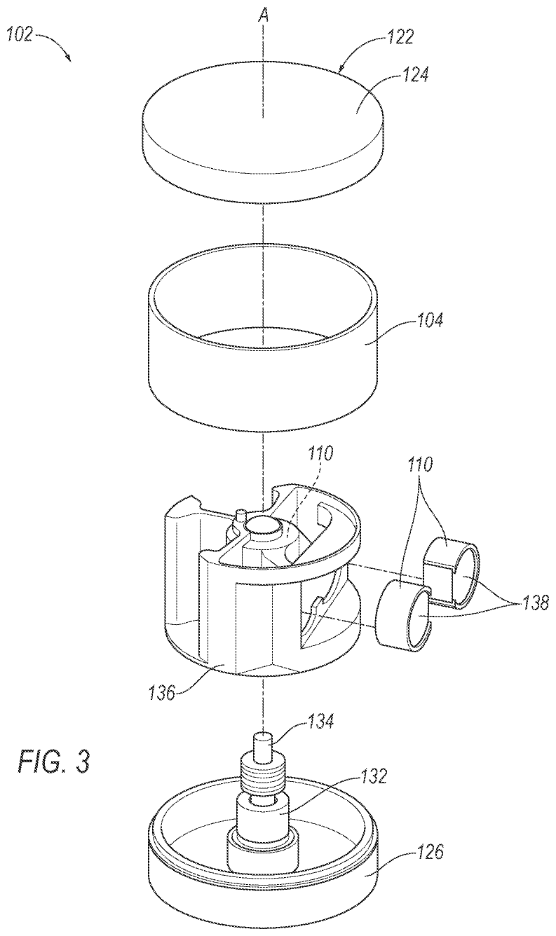

The sensor system 102 may be designed to detect features of the outside world; for example, the sensor system 102 may include a radar sensor, a scanning laser range finder, a light detection and ranging (LIDAR) device, or an image processing sensor such as a camera. In particular, the sensor system 102 may be a LIDAR device, e.g., a scanning LIDAR device. A LIDAR device detects distances to objects by emitting laser pulses at a particular wavelength and measuring the time of flight for the pulse to travel to the object and back. The operation of the sensor system 102 is performed by the sensing device 110 (shown in FIG. 3) inside the sensor housing 122. The sensing device 110 has a field of view through the sensor window 104 encompassing a region from which the sensor system 102 receives input, as shown in FIG. 7.

The sensor housing 122 includes a sensor-housing cap 124, the sensor window 104, and a sensor-housing base 126. The sensor-housing cap 124 is disposed directly above the sensor window 104, and the sensor-housing base 126 is disposed directly below the sensor window 104. The sensor-housing cap 124 and the sensor-housing base 126 are vertically spaced apart by a height of the sensor window 104.

The sensor window 104 is oriented generally vertically, i.e., extends up and down. The sensor window 104 is cylindrical and defines the axis A, which is oriented vertically. The sensor window 104 extends around the axis A. The sensor window 104 can extend fully around the axis A, i.e., 360°, or partially around the axis A. The sensor window 104 extends along the axis A, i.e., vertically, from a bottom edge 128 to a top edge 130. The bottom edge 128 contacts the sensor-housing base 126, and the top edge 130 contacts the sensor-housing cap 124. The sensor window 104 includes an exterior surface facing radially outward relative to the axis A. The sensor window 104 has an outer diameter, i.e., a diameter of the exterior surface. The outer diameter of the sensor window 104 may be the same as an outer diameter of the sensor-housing cap 124 and/or of the sensor-housing base 126; in other words, the sensor window 104 may be flush or substantially flush with the sensor-housing cap 124 and/or the sensor-housing base 126. “Substantially flush” means a seam between the sensor window 104 and the sensor-housing cap 124 or sensor-housing base 126 does not cause turbulence in air flowing along the sensor window 104. At least some of the sensor window 104 is transparent with respect to whatever medium the sensing device 110 is capable of detecting. For example, if the sensor system 102 is a LIDAR device, then the sensor window 104 is transparent with respect to visible light at the wavelength generated and detectable by the sensing device 110. The field of view of the sensing device 110 extends through the sensor window 104.

With reference to FIG. 3, the sensor system 102 includes a motor 132. The motor 132 can be, e.g., an electric motor with a rotational output. The motor 132 is drivably coupled to the sensing device 110, e.g., via an output shaft 134 rotationally fixed to a carriage 136. The motor 132 can be configured to operate at a preset angular speed, i.e., to either rotate the output shaft 134 at the preset angular speed when activated or not rotate the output shaft 134 when deactivated. The sensing device 110 is thus configured to rotate around the axis A at the preset angular speed.

The sensor system 102 includes the carriage 136. The carriage 136 is a rigid component to which other components of the sensor system 102 can be mounted, e.g., the sensing device 110. The carriage 136 is rotationally fixed to the output shaft 134, e.g., by keying. The carriage 136 and the components mounted to the carriage 136 rotate around the axis A together when the motor 132 is activated. The carriage 136 is sized to fit within the sensor window 104, e.g., by having an outer diameter slightly smaller than an inner diameter of the sensor window 104.

The sensing device 110 is fixedly mounted to the carriage 136 and rotatable around the axis A via the carriage 136. If the sensing device 110 is a LIDAR sensing device, then the sensing device 110 can include a laser, a mirror, a receiver (not shown), and lenses 138 for transmitting and receiving. When the mirror rotates with the carriage 136, the mirror directs a beam from the laser through the lenses 138 to the environment. The beam reflects off of a feature of the environment back to the lenses 138, which direct the reflected beam to the receiver. The lenses 138 define a field of view of the sensing device 110. The field of view of the sensing device 110 passes through the sensor window 104 in at least one position of the sensing device 110, e.g., in all positions of the sensing device 110 for 360° around the axis A.

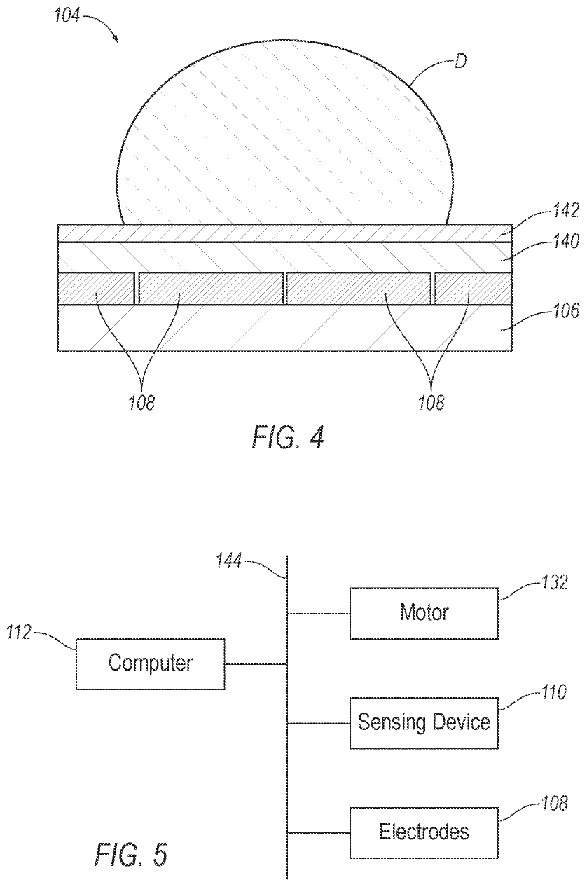

With reference to FIG. 4, the sensor window 104 includes the substrate 106. The sensor window 104 may be any suitably durable transparent material, including glass or plastic, e.g., Plexiglas® or polycarbonate.

The electrodes 108 are applied to the substrate 106, specifically to a radially outer surface of the substrate 106. The electrodes 108 are transparent, and the field of view of the sensing device 110 passes through a subset of the electrodes 108 in each position of the sensing device 110. Each electrode 108 can be activated by applying a voltage to the electrode 108. The electrodes 108 can be any material that is both transparent and able to hold a charge, e.g., indium tin oxide (ITO).

The sensor window 104 includes a dielectric layer 140 positioned over the electrodes 108. The dielectric layer 140 can be applied directly on the electrodes 108. The dielectric layer 140 is a material that is electrically insulating and able to be polarized by an electric field, e.g., by the electrodes 108 when charged. A nearby charge causes dielectric polarization in the dielectric layer 140, meaning electrical charges shift from their average equilibrium positions without flowing through the dielectric material.

The sensor window 104 can include a hydrophobic coating 142 over the electrodes 108, e.g., over the dielectric layer 140. The hydrophobic coating 142 can be applied directly on the dielectric layer 140. The hydrophobic coating 142 is the radially outermost layer of the sensor window 104, i.e., is exposed to the external environment. When a droplet lands on the sensor window 104, the droplet interacts with the hydrophobic coating 142. The hydrophobic coating 142 is hydrophobic, meaning that water on the hydrophobic coating 142 tends to have a large contact angle.

The sensor window 104 is capable of electrowetting, i.e., moving droplets D along a surface using electrostatic force. Activating one of the electrodes 108 next to a droplet D generates an electrostatic force on the droplet D pulling the droplet toward that electrode 108, called electrowetting. That electrode 108 can then deactivate while an adjacent electrode 108 can activate, continuing to pull the droplet D. The insulation provided by the dielectric layer 140 prevents a discharge between the droplet D and the electrodes 108, preserving the potential difference that causes the electrostatic force. The dielectric polarization of the dielectric layer 140 can magnify the potential difference, increasing the electrostatic force. The hydrophobic coating 142 makes the droplets D move more easily during the electrowetting process by lowering an adhesion force resisting motion of the droplet D.

With reference to FIG. 5, the computer 112 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 112 can thus include a processor, a memory, etc. The memory of the computer 112 can include media for storing instructions executable by the processor as well as for electronically storing data and/or databases, and/or the computer 112 can include structures such as the foregoing by which programming is provided. The computer 112 can be multiple computers coupled together.

The computer 112 may transmit and receive data through a communications network 144 such as a controller area network (CAN) bus, Ethernet, WiFi, Local Interconnect Network (LIN), onboard diagnostics connector (OBD-II), and/or by any other wired or wireless communications network. The computer 112 may be communicatively coupled to the motor 132, the sensing device 110, the electrodes 108, and other components via the communications network 144.

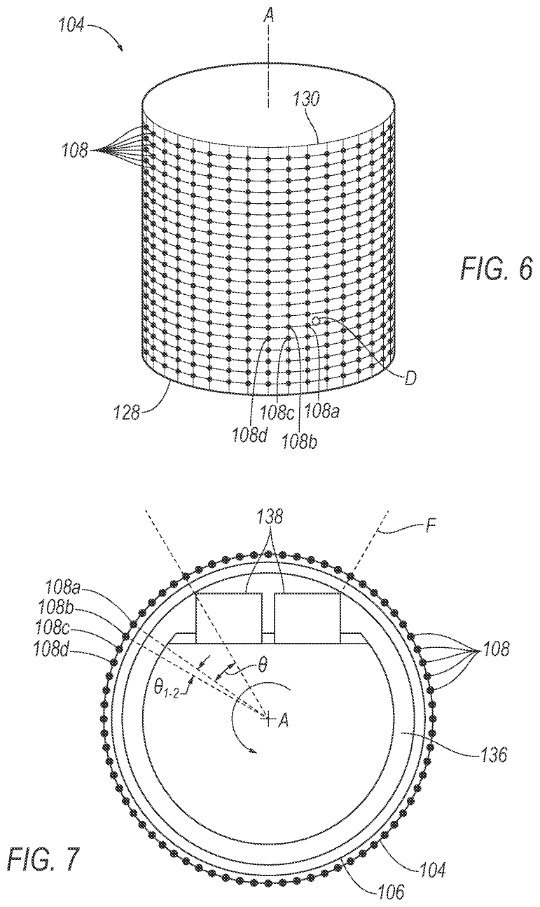

With reference to FIG. 6, the electrodes 108 can be arranged in a grid on the substrate 106. The grid of electrodes 108 can extend circumferentially fully around the axis A, i.e., 360°. The grid of electrodes 108 can extend axially, i.e., along the axis A, from the bottom edge 128 to the top edge 130 of the sensor window 104. The electrodes 108 can have circumferentially adjacent electrodes 108 in two directions and axially adjacent electrodes 108 in two directions unless positioned at the bottom edge 128 or top edge 130.

With reference to FIGS. 6 and 7, the computer 112 is programmed to activate the electrodes 108 in a sequence that electrostatically moves a droplet on the sensor window 104. For the purposes of this disclosure, a sequence of activation is defined as an order in which the electrodes 108 are activated. The sequence includes consecutively activating adjacent electrodes 108 to pass the droplet D from one electrode 108 to the next electrode 108. The electrodes 108 are activated for brief durations that are sufficiently long to move droplets D, e.g., on the order of milliseconds. The sequence can include consecutively activating circumferentially adjacent electrodes 108 and axially adjacent electrodes 108.

The sequence of activating the electrodes 108 is coordinated with movement of the sensing device 110 relative to the sensor window 104. For example, the sequence of activating the electrodes 108 includes activating the electrodes 108 in a same direction, e.g., a same circumferential direction, as movement of the field of view F of the sensing device 110, e.g., as shown in FIGS. 6 and 7, in order, a first electrode 108a, a second electrode 108b, a third electrode 108c, a fourth electrode 108d, etc. In particular, the sequence can include activating the electrodes 108 around the axis A at the preset angular speed of the motor 132. In other words, for example, the first electrode 108a is activated at a time t₀, and the second electrode 108b, e.g., circumferentially adjacent to the first electrode 108a, is activated at a time t₁=t₀+θ₁₋₂/ω, in which θ₁₋₂ is an angle relative to the axis A between the first electrode 108a and the second electrode 108b, and ω is the preset angular speed. A currently activated electrode 108 is thus at a constant angle θ from the field of view F of the sensing device 110 in the direction of rotation of the sensing device 110. The angle θ can be, e.g., at most 45°. A small angle θ means that the field of view F of the sensing device 110 is through a portion of the sensor window 104 that has been recently electrowetted.

Alternatively or additionally, the sequence of activating the electrodes 108 can include activating the electrodes 108 axially, e.g., in a downward direction. For example, as shown in FIG. 6, the sequence of activating the electrodes 108 includes activating electrodes 108 that are circumferentially adjacent in the direction of rotation of the sensing device 110 as well as activating electrodes 108 that are axially adjacent in a downward direction. The sequence can continue until the droplet is pulled to the bottom edge 128 of the sensor window 104.

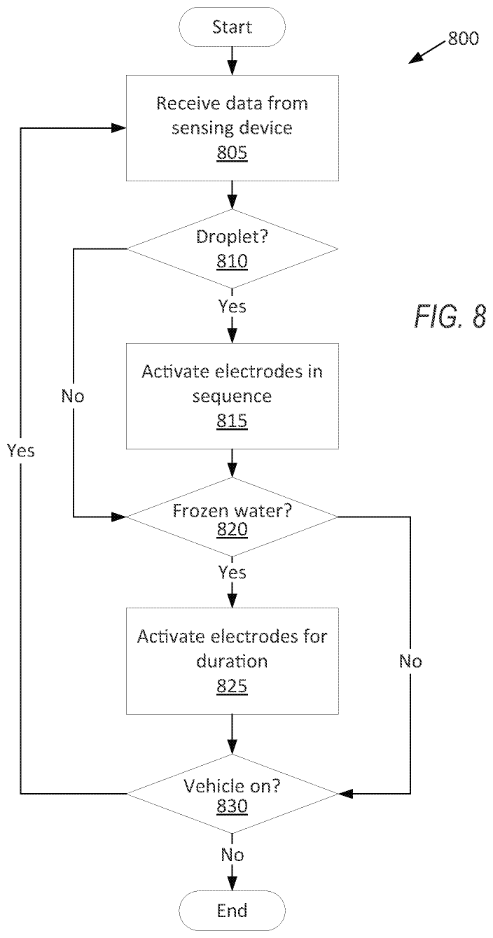

FIG. 8 is a process flow diagram illustrating an exemplary process 800 for operating the electrodes 108. The memory of the computer 112 stores executable instructions for performing the steps of the process 800 and/or programming can be implemented in structures such as mentioned above. As a general overview of the process 800, the computer 112 receives data from the sensing device 110. In response to the data indicating a presence of a droplet, the computer 112 activates the electrodes 108 in the sequence described above. In response to the data indicating frozen water on the sensor window 104, the computer 112 activates the electrodes 108 for a duration to melt the frozen water. The process 800 continues for as long as the vehicle 100 is on.

The process 800 begins in a block 805, in which the computer 112 receives data from the sensing device 110. The data can be, e.g., LIDAR data of directions and distances to objects in the environment.

Next, in a decision block 810, the computer 112 determines whether the data from the sensing device 110 indicates a presence of a droplet on the sensor window 104. For example, the data can indicate that an object is at a distance approximately equal to the outer radius of the sensor window 104 and has a length or area in a preset range. The preset range can be chosen based on a typical size of droplets on the hydrophobic coating 142. In response to the data indicating the presence of the droplet, the process 800 proceeds to a block 815. In response to the data failing to indicate the presence of any droplets, the process 800 proceeds to a decision block 820.

In the block 815, the computer 112 activates the electrodes 108 in the sequence that electrostatically moves the droplet on the sensor window 104, e.g., circumferentially and to the bottom edge 128 of the sensor window 104, as described above. After the block 815, the process 800 proceeds to the decision block 820.

In the decision block 820, the computer 112 determines whether the data from the sensing device 110 indicates frozen water on the sensor window 104. Frozen water can include ice, frost, snow, etc. For example, the data can indicate that an object is at a distance approximately equal to the outer radius of the sensor window 104 and is not moving relative to the sensor window 104. The computer 112 may also receive an ambient temperature from a temperature sensor of the vehicle 100 or from weather data transmitted to the vehicle 100, and the computer 112 may determine that the unmoving object on the sensor window 104 is frozen water only if the ambient temperature is at or below freezing. In response to the data indicating frozen water on the sensor window 104, the process 800 proceeds to a block 825. In response to the data failing to indicate frozen water on the sensor window 104, the process 800 proceeds to a decision block 830.

In the block 825, the computer 112 activates the electrodes 108 to melt the frozen water. For example, the computer 112 can activate a subset of the electrodes 108 that are at locations on the sensor window 104 directly beneath the frozen water for an extended duration. The duration can be for as long as the data from the sensing device 110 indicates that the frozen water is present. The duration is longer than the duration of activation of each electrode 108 when activating the electrodes 108 in the sequence in the block 815. After the block 825, the process 800 proceeds to the decision block 830.

In the decision block 830, the computer 112 determines whether the vehicle 100 is still on. If the vehicle 100 is still on, the process 800 returns to the block 805 to continue receiving data from the sensing device 110. If the vehicle 100 has been turned off, the process 800 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship. The adjectives “first,” “second,” etc. are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A sensor system comprising:
a sensor window including a substrate and a plurality of electrodes applied to the substrate;
a sensing device movable relative to the sensor window and having a field of view through the sensor window in at least one position; and
a computer communicatively coupled to the sensing device and the electrodes;
wherein the computer is programmed to activate the electrodes in a sequence that electrostatically moves a droplet on the sensor window, the sequence being coordinated with movement of the sensing device relative to the sensor window.

2. The sensor system of claim 1, wherein the sensor window is cylindrical and defines an axis, and the sensing device is rotatable around the axis.

3. The sensor system of claim 2, wherein the sensing device is configured to rotate around the axis at a preset angular speed, and the sequence of activating the electrodes includes activating the electrodes around the axis at the preset angular speed.

4. The sensor system of claim 3, wherein the sequence of activating the electrodes includes activating the electrodes located at an angle from the field of view of the sensing device in a direction of rotation of the sensing device relative to the axis, and the angle is at most 45°.

5. The sensor system of claim 1, wherein the sequence of activating the electrodes includes activating the electrodes in a downward direction.

6. The sensor system of claim 1, wherein the electrodes are arranged in a grid on the substrate.

7. The sensor system of claim 1, wherein the electrodes are transparent.

8. The sensor system of claim 1, wherein the electrodes are indium tin oxide.

9. The sensor system of claim 1, wherein the sensor window includes a hydrophobic coating over the electrodes.

10. The sensor system of claim 1, wherein the sensor window includes a dielectric layer over the electrodes.

11. The sensor system of claim 10, wherein the sensor window includes a hydrophobic coating over the dielectric layer.

12. The sensor system of claim 1, wherein the computer is further programmed to activate the electrodes in the sequence in response to receiving data from the sensing device indicating a presence of the droplet.

13. The sensor system of claim 1, wherein the computer is further programmed to activate the electrodes in response to receiving data from the sensing device indicating frozen water on the sensor window.

14. The sensor system of claim 1, wherein the sensing device is a LIDAR sensing device.

15. A computer comprising a processor and a memory storing instructions executable by the processor to:
activate a plurality of electrodes in a sequence that electrostatically moves a droplet on a sensor window including the electrodes and a substrate to which the electrodes are applied;
wherein the sequence is coordinated with movement of a sensing device relative to the sensor window.

16. The computer of claim 15, wherein the sequence of activating the electrodes includes activating the electrodes in a same direction as movement of a field of view of the sensing device.

17. The computer of claim 15, wherein the instructions further include instructions to activate the electrodes in the sequence in response to receiving data from the sensing device indicating a presence of the droplet.

18. The computer of claim 15, wherein the instructions further include instructions to activate the electrodes in response to receiving data from the sensing device indicating frozen water on the sensor window.

19. The computer of claim 18, wherein activating the electrodes in response to frozen water includes activating a subset of the electrodes for a duration longer than a duration of activation when activating the electrodes in the sequence.

20. A method comprising:
activating a plurality of electrodes in a sequence that electrostatically moves a droplet on a sensor window including the electrodes and a substrate to which the electrodes are applied;
wherein the sequence is coordinated with movement of a sensing device relative to the sensor window.
